(19) United States
(12) Patent Application Publication
(10) Pub. No.: US 2021/0382860 A1
(43) Pub. Date: Dec. 9, 2021

(54) METHODS FOR MONITORING A BLOCKCHAIN BASED ON SCHEMATIZED TRANSACTIONS AND DEVICES THEREOF

(71) Applicant: BlocWatch Inc., Reno, NV (US)

(72) Inventors: Aaron Newman, Pittsford, NY (US); Jason Ruckman, Rochester, NY (US); Angus Davis, Rochester, NY (US)

(21) Appl. No.: 16/894,560

(22) Filed: Jun. 5, 2020

(51) Int. Cl. G06F 16/21; G06F 16/23

(52) U.S. Cl. CPC G06F 16/211; G06F 16/2365

(57) ABSTRACT

A method, non-transitory computer readable medium, and device that monitors a blockchain based on one or more schematized transactions includes ingesting a block of a blockchain for monitoring. A transaction of the block is schematized to identify one or more fields for data types in the received transaction. A determination is made whether data in one or more of the identified fields of the schematized transaction matches one or more conditions of one or more rules associated with at least one stored policy. Execution of at least one action is triggered based on the determination that the data in at least one of the identified fields of the schematized transaction matches at least one of the conditions of one of the rules associated with the at least one stored policy.

### FIELD

This technology relates to methods and devices that monitor a blockchain based on schematized transactions.

### BACKGROUND

Blockchain is a concept that was first implemented successfully by Satoshi Nakamoto in 2008 as the basis for a new form of currency called BitCoin. The concept and system was shared in the white paper “Bitcoin: A Peer-to-Peer Electronic Cash System” downloadable from https://bitcoin.org/bitcoin.pdf. Bitcoin is a type of blockchain that creates a digital currency.

Blockchain is a system that records transactions into a public ledger in a way that is indisputable and secure. The public ledger is shared amongst a distributed network of independent nodes. Cryptocurrencies have been the initial and leading use-case for blockchain. The cryptocurrencies are built on top of blockchains and use the indisputability characteristics to provide an accurate count of coins and to restrict use of coins to only the people to which they belong.

Blockchain has evolved quickly into much more general-purpose systems to record and manage all form of digital assets, not just coins.

One of the leading data propositions of a blockchain is the idea of performing trustless computing. Previously transactions required trusted third parties to ensure both parties to the transaction were real and trustworthy. An entire industry exists around Letters of Credit to ensure a company can ship goods and will receive payment for the goods. Without Letters of Credit, many transactions between parties would not be able to occur, and the fear of fraud would hold back significant parts of the global economy.

Blockchain provides advantages over these prior systems, such as Letters of Credit. To start with, the blockchain allows significantly more transactions to occur because they can perform a micro-transaction, can run transactions at scale, and are automated. Additionally, blockchains reduce expenses by eliminating prior charges by third-party arbitrators.

The key concepts of a blockchain include:

Distribution—the network of the blockchain is run on many nodes.

Encryption—blockchains use hashes and both symmetric and asymmetric cryptography to enforce security. Security is NOT enforced by a central authority.

Immutability—records written into a blockchain should not be trivially modified or deleted.

Tokenization—an asset in the blockchain is represented by a secure token that can only be controlled by the owner secured by a private key.

Decentralization—no single or centralized entity can control or manipulate the network.

Each of these concepts are components of a blockchain that enable the trustless computing for which blockchain promises us.

### Public vs Private

Blockchains have emerged in a few different forms. Two main classifications are public and private (or permissioned). Public blockchains have advantages of being much more scalable. The security provided by proof-of-work or proof-of-stake consensus algorithms is very powerful. As well, the fact they are open means many, many more people can participate.

Private blockchains run on networks nodes that are limited to users that are authorized to participate. A user must be granted permission to operate within a private blockchain (hence the name “permissioned blockchain”).

### How a Blockchain Works

Basically, blockchains are chains of blocks. More specifically, written as a ledger, a blockchain writes transactions into groups called blocks. Each transaction is signed using a hash. The transactions are grouped into a tree and each branch along the tree is signed as well as the top of the tree. This is referred to as a Merkle tree. Each individual transaction can be looked up and validated by traversing the tree. The complete text of each block is also signed and includes the signature of the previous block. This effectively creates a chain that can be validated by following the hashes.

Anyone in a blockchain network can submit a transaction. The transaction can only act on tokens that the submitter owns. The transaction must contain proof that the submitter has the private key associated with the token. The blockchain can verify this by validating the transaction using the public key associated with the token. If the transaction does not match it is thrown out by everyone minting new blocks. Every node also checks all transactions for new blocks it receives from other nodes, and again throws it out if any transaction does not validate.

One form of consensus is “proof-of-work”. This is the most common consensus used by cryptocurrencies. Proof-of-work is based on creating a very hard math problem to solve. The first node to solve the math problem finalizes the block and submits it and gets rewarded or paid some cryptocurrency for their work. This creates massive networks of people running nodes to ensure all transactions are valid because they are competing for the reward.

### Leading Blockchains

The most widely-accepted blockchain platforms currently include Ethereum, Hyperledger, Quorom (an extension of Ethereum), and R3 Corda. Each has different sets of capabilities, different formats for the blocks and transactions, different protocols to share blocks, and is managed and controlled by a different organization. Yet all are based on the concept of a blockchain as proposed by Satoshi Nakamoto in the original Bitcoin protocol.

Accordingly, the use and applications of blockchains are rapidly expanding and as noted above provide a number of advantages, including accuracy, speed and lower cost. However, existing technological solutions to manage these growing numbers of blockchains are very limited. In particular, existing technological solutions have little to no effective manner for monitoring and otherwise managing any actions with respect to transactions which are stored in these blockchains.

### SUMMARY

An example of a method for monitoring a blockchain based on one or more schematized transactions includes ingesting, by a computing device, a block of a blockchain for monitoring. A transaction of the block is schematized, by the computing device, to identify one or more fields for one or more data types in the transaction. A determination is made, by the computing device, whether data in one or more of the identified fields of the schematized transaction matches one or more conditions of one or more rules associated with at least one stored policy. Execution of at least one action is triggered, by the computing device, based on the determination that the data in at least one of the identified fields of the schematized transaction matches at least one of the conditions of one of the rules associated with the at least one stored policy.

An example of a non-transitory computer readable medium having stored thereon instructions comprising executable code that, when executed by one or more processors, causes the one or more processors to ingest a block of a blockchain for monitoring. A transaction of the block is schematized to identify one or more fields for one or more data types in the transaction. A determination is made whether data in one or more of the identified fields of the schematized transaction matches one or more conditions of one or more rules associated with at least one stored policy. Execution of at least one action is triggered based on the determination that the data in at least one of the identified fields of the schematized transaction matches at least one of the conditions of one of the rules associated with the at least one stored policy.

An example of a blockchain monitoring computing device, comprising memory comprising programmed instructions stored thereon and one or more processors configured to be capable of executing the stored programmed instructions to ingest a block of a blockchain for monitoring. A transaction of the block is schematized to identify one or more fields for one or more data types in the transaction. A determination is made whether data in one or more of the identified fields of the schematized transaction matches one or more conditions of one or more rules associated with at least one stored policy. Execution of at least one action is triggered based on the determination that the data in at least one of the identified fields of the schematized transaction matches at least one of the conditions of one of the rules associated with the at least one stored policy.

This technology provides a number of advantages including providing methods, non-transitory computer readable media and devices that enable effective monitoring of a blockchain based on schematized transactions. In particular, examples of the claimed technology provide a transparent infrastructure that enables monitoring of transactions within a blockchain and providing rules based alerts when anomalous or other important events are detected. To enable this monitoring and alert generation, examples of this technology use schemas on transactions within a blockchain to define fields for different data types and actions for data in those defined fields. Examples of this technology will derive the schema and use that information to monitor how transactions are being acted on. In addition to monitoring, examples of this technology also provide an alerting system which utilizes a set of default alerts along with custom and behavioral alerts to detect actions that may require reactions or attention, such as by an administrator of the blockchain or a security team supporting the blockchain.

### BRIEF DESCRIPTION OF THE DRAWINGS

FIG. 1 is a block diagram of an exemplary blockchain monitoring system with a blockchain monitoring computing device;

FIG. 2 is a block diagram of an exemplary blockchain monitoring computing device;

FIG. 3 is a flowchart of an exemplary method for executing an inventory to identify one or more blocks within a blockchain; and

FIG. 4 is a flow chart of an exemplary method for monitoring one or more schematized transaction within one or more blocks within a blockchain.

### DETAILED DESCRIPTION

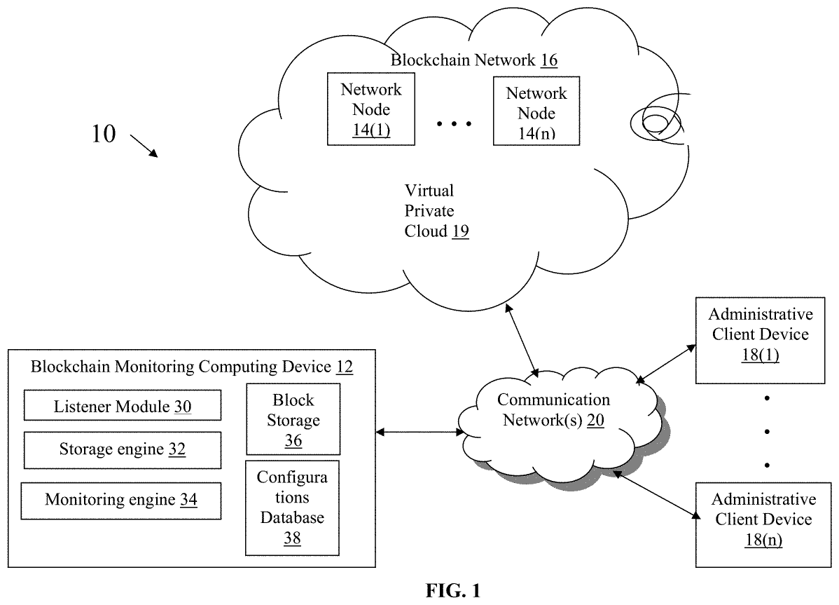

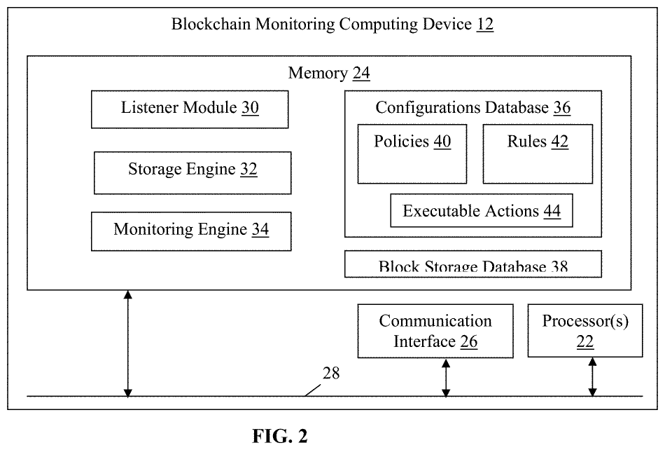

A blockchain system 10 with a blockchain monitoring computing device 12 is illustrated in FIGS. 1-2. In this example, the blockchain system 10 includes the blockchain monitoring computing device 12 that is coupled to network nodes 14(1)-14(n) in the exemplary blockchain network 16 operating in a virtual private cloud 19, and administrative client devices 18(1)-18(n) via one or more other communication network(s) 20, although the blockchain monitoring computing device 12, network nodes 14(1)-14(n), and/or administrative client devices 18(1)-18(n) may be coupled together via other topologies. The blockchain system 10 may also include other systems and/or devices which are known in the art and thus will not be described herein. This technology provides a number of advantages including providing methods, non-transitory computer readable media, and devices that enable effective monitoring of a blockchain based on schematized transactions.

In this particular example, the blockchain monitoring computing device 12, the network nodes 14(1)-14(n) in the exemplary blockchain network 16, and the administrative client devices 18(1)-18(n) are disclosed in FIG. 1 as dedicated hardware devices in different networks. However, one or more of the blockchain monitoring computing device 12, the network nodes 14(1)-14(n) in the exemplary blockchain network 16, or the administrative client devices 18(1)-18(n) can also be implemented virtually and/or in software within one or more other devices in the blockchain system. For example, the blockchain monitoring computing device 12 can be partially or entirely hosted by one or more of the network nodes 14(1)-14(n) in the exemplary blockchain network 16, although other network configurations can be used.

Referring to FIGS. 1-2, the blockchain monitoring computing device 12 of the blockchain system 10 may perform any number of operations and other functions as illustrated and described by way of the examples herein, including enabling effective monitoring of a blockchain based on schematized transactions, for example. The blockchain monitoring computing device 12 in this example includes processor(s) 22, a memory 24, and a communication interface 26, which are coupled together by a bus 28, although the blockchain monitoring computing device 12 can include other types or numbers of elements in other configurations.

The processor(s) 22 of the blockchain monitoring computing device 12 may execute programmed instructions stored in the memory 24 of the blockchain monitoring computing device 12 for any number of functions described and illustrated by way of the examples herein, including enabling effective monitoring of a blockchain based on schematized transactions, for example. The processor(s) 22 of the blockchain monitoring computing device 12 may include one or more central processing units (CPUs) or general purpose processors with one or more processing cores, for example, although other types of processor(s) can also be used.

The memory 24 of the blockchain monitoring computing device 12 stores these programmed instructions for aspect(s) of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 22, can be used for the memory 24.

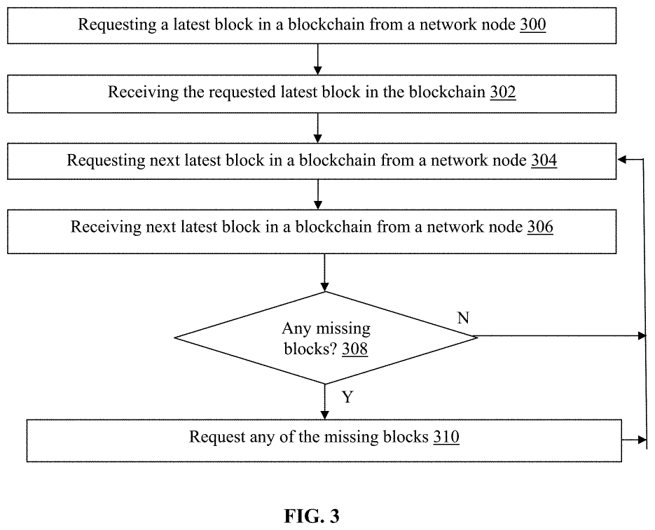

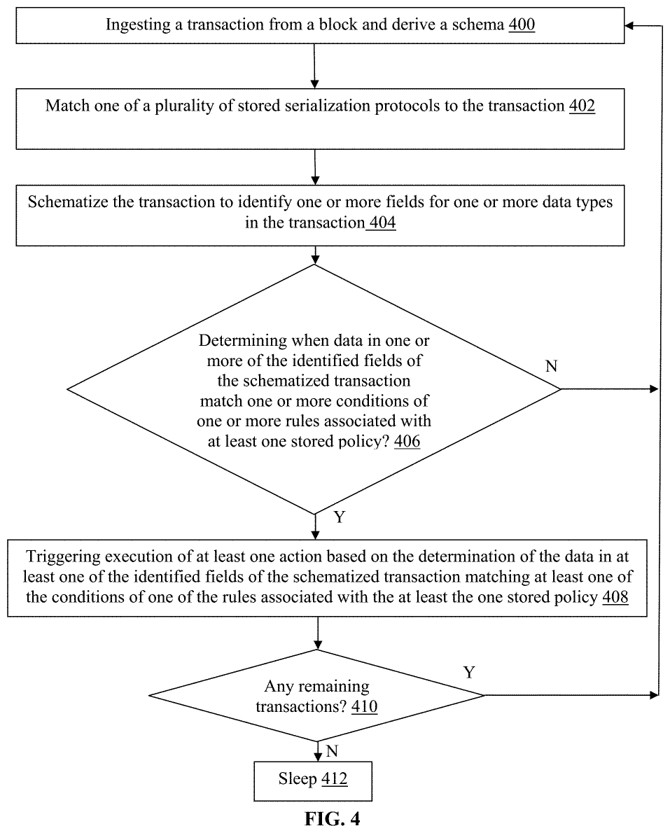

Accordingly, the memory 24 of the blockchain monitoring computing device 12 can store module(s), engine(s), and/or other program(s) that can include computer executable instructions that, when executed by the blockchain monitoring computing device 12, cause the blockchain monitoring computing device 12 to execute instructions or perform other operations as described and illustrated by way of the examples herein, including those described and illustrated with respect to FIGS. 3-4. The module(s), engine(s), and/or other program(s) can be implemented as components of other module(s), engine(s), and/or program(s). Further, the module(s), engine(s), and/or other program(s) can be implemented as applications, operating system extensions, plugins, or the like.

Even further, the module(s), engine(s), and/or other program(s) may be operative in a cloud-based computing environment. The module(s), engine(s), and/or other program(s) can be executed within or as virtual machine(s) or virtual server(s) that may be managed in a cloud-based computing environment. Also, the module(s), engine(s), and/or program(s), and even the blockchain monitoring computing device 12 itself, may be located in virtual server(s) running in a cloud-based computing environment rather than being tied to specific physical network computing device(s). Also, the module(s), engine(s), and/or other program(s) may be running in one or more virtual machines (VMs) executing on one or more of the network nodes 14(1)-14(n) in the exemplary blockchain network 16 or in one or more other computing apparatuses.

In this particular example, the memory 24 of the blockchain monitoring computing device 12 also includes a listener module 30, a storage engine 32, a monitoring engine 34, a block storage database 38, and a configuration database 38, although the memory 24 can include other modules, engines, programs, policies, rules, databases, and/or other information, for example.

In this example, the listener module 30 is configured to create a listener of the blockchain network 16 that can communicate with one of the network nodes 14(1)-14(n), although the listener module 30 could be configured in other manners and for other types and/or numbers of other operations or other actions. The listener module 30 requires network connectivity to at least one of the network nodes 14(1)-14(n) that is active. In this example, an agent can be installed on the same host as one of the network nodes 14(1)-14(n) to enable communications, such as about blocks, with blockchain monitoring computing device 12, although in other examples may run on a light-weight host physically or virtually to monitor the one of the network nodes 14(1)-14(n) of the blockchain network 16. In this example, the listener module 30 executed by the blockchain monitoring computing device 12 is operating in the same virtual private cloud 19 as the network nodes 14(1)-14(n) of the blockchain network 16, although other configurations could be used. Additionally, although described with a private blockchain in this example, other examples of this technology may operate in the same manner with public blockchains. The listener module 30 is also configured to pack each block into a set that will be transmitted back to the blockchain monitoring computing device 12 to be ingested or processed, such as by one or more of the storage engine 32 and/or the monitoring engine 34.

In an alternate implementation of this technology, a listener network node may be created in the blockchain network 16, in this example, that actively participates with other network nodes 14(1)-14(n) in the blockchain network 16 and is configured to be utilized to acquire and provide blocks in the blockchain to the blockchain monitoring computing device 12. In this example, the listener network node is not configured to run as a full network node (like one of the network nodes 14(1)-14(n) in the blockchain network 16). As a result, the listener network node in this implementation can run more efficiently by, for example, not having to mint blocks, not participate in consensus (such as endorsing, validating, or “proof-of-work” by way of example), not participate in the broadcast protocols, and not participate in other administrative tasks.

The storage engine 32 in this example is configured to load blocks or sets of identified blocks, parse the sets of identified blocks into individual blocks and individual transactions with each block, and then save that into the block storage database 38 that will later be used to provide analysis over time or even query capabilities over historical data, although the storage engine 32 could be configured for other types and/or numbers of other operations or other actions.

The monitoring engine 34 in this example is configured to load a list of one or more stored policies for the blockchain being monitored, analyze one or more of the loaded policies against data in defined fields in schematized transactions, and determine what action may be required based on the analysis, although the monitoring engine 34 could be configured for other types and/or numbers of other operations or other actions. Additionally, the monitoring engine 34 may be configured to execute one of a plurality of actions, such as generating and transmitting a notification that provides an alert or other data. In this example, the notification could be a text message or an email sent to one of the administrative computing devices 18(1)-18(n) designated by the corresponding one of the stored policies or otherwise identified.

The block storage database 38 is configured to store sets of identified blocks, individual blocks, and individual transactions in each of the blocks, although the block storage database 38 could store other types and/or numbers of other data and/or instructions.

The configuration database 36 stores one or more policies 40 for blockchains, although this database could store other types of data and/or instructions. Each of the policies 40 are correlated to one or more stored rules 42 which each have one or more conditions that are each associated with one or more stored executable actions 44, although the configuration database 36 could store other types and/or numbers of other data and/or instructions. Accordingly, in this example the monitoring engine 34 uses each of the stored policies 40 with the rules 42 having one or more conditions to determine when one of a plurality of executable actions 44 is triggered, such as transmission of a particular notification, although the policies and/or rules with conditions could be configured in other manners. Additionally, in this example each of the rules 42 is mapped to one or more executable actions 44, such as notifications to one or more designated addresses by way of example, although other manners for obtaining executable actions could be used and other types of executable actions may be implemented, such as one or more executable security actions.

In this example, the configuration database 36 comprises three types of stored policies, e.g. infrastructure policies, user generated policies, and behavioral policies, although the configuration database 36 may have other types and/or numbers of stored policies.

In this example, infrastructure policies typically are universally applicable policies, regardless of the particular blockchain, that are established and require no further input. By way of example, infrastructure policies may include standard errors, warnings, or actions that can and will occur in a blockchain without having to know anything about the proprietary blockchain schema. For instance, if one of the network nodes 14(1)-14(n) is attempting to create invalid transactions, the one of the network nodes 14(1)-14(n) will fail. The invalid transactions will not make it into the blockchain because of the consensus of a blockchain, however the infrastructure policies may include a policy about an executable action comprising providing a notification when these failures occur so that one of the administrative computing devices 18(1)-18(n), for example, could investigate. Another example of an infrastructure policy may be if a network node itself fails or a new node is added to the network, then this would trigger an executable action, such as a notification to one of the administrative computing devices 18(1)-18(n) or execution of an automated failover to a replacement node in the network, for example.

In this example, user-generated policies are created ad-hoc by an operator at one of the administrative computing devices 18(1)-18(n), for example, and may be customized for a particular blockchain. In this example, an operator at one of the administrative computing devices 18(1)-18(n) may connect to the blockchain monitoring computing device 12 using a web user interface or through an API and selecting fields and parameters for data in those fields for conditions in the rules 42, although other manners for generating or otherwise providing policies may be used.

By way of example, an operator at one of the administrative computing devices 18(1)-18(n) may create a user-generated policy that states: If the number of Widgets transferred in a transaction is greater than 25, then satisfaction of this condition triggers an executable execution, such as transmission of a particular notification related to the condition and data. These user-generated policies require an operator at one of the administrative computing devices 18(1)-18(n), for example, to predict the type of condition for which an executable action is triggered.

In this example, behavioral policies are another type of policies that analyze a sample of transactions on a blockchain and then apply one or more machine learning algorithms to determine what is typical or to establish other patterns or limits for setting behavioral policies with executable actions. In this example, once one or more data in defined fields in a transaction are baselined or otherwise quantified, for example based on statistical analysis, then a behavioral policy can be configured to trigger an executable action or actions when a transaction or set of transactions is not-normal. One advantage of behavioral policies based on trained artificial intelligence is that user-generated policies cannot predict or otherwise identify all scenarios that need to be addressed.

The communication interface 26 of the blockchain monitoring computing device 12 operatively couples and communicates between the blockchain monitoring computing device 12, network nodes 14(1)-14(n) in the exemplary blockchain network 16, and administrative client devices 18(1)-18(n) which are coupled together at least in part by one or more other communication network(s) 20, although other types and/or another number of communication networks or systems with other types and/or another number of connections and/or configurations to other devices and/or elements can also be used.

By way of example only, the virtual private cloud 19 and/or one or more communication network(s) 20 can include local area network(s) (LAN(s)) or wide area network(s) (WAN(s)), and can use TCP/IP over Ethernet and industry-standard protocols, although other types or numbers of protocols or communication networks can be used. The virtual private cloud 19 and/or one or more communication network(s) 20 in this example can employ any suitable interface mechanisms and network communication.

While the blockchain monitoring computing device 12 is illustrated in this example as including a single device, the blockchain monitoring computing device 12 in other examples can include a plurality of devices or instances each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the blockchain monitoring computing device 12.

Additionally, one or more of the devices that together comprise the blockchain monitoring computing device 12 in other examples can be standalone devices or integrated with one or more other devices or apparatuses, such as one or more of the network nodes 14(1)-14(n) in the exemplary blockchain network 16, for example. Moreover, one or more of the devices of the blockchain monitoring computing device 12 in these examples can be in a same or a different communication network including one or more public, private, or cloud networks, for example.

Each of the network nodes 14(1)-14(n) in the exemplary blockchain network 16 in this example includes processor(s), a memory, and a communication interface, which are coupled together by a bus or other communication link, although other numbers or types of components could be used. The network nodes 14(1)-14(n) in the exemplary blockchain network 16 in this example can include blockchain servers, for example, although other types of server or other physical or virtual computing devices can also be included in the blockchain network 16.

In some examples, one or more of the network nodes 14(1)-14(n) in the exemplary blockchain network 16 process blockchain transactions received from the administrative client devices 18(1)-18(n) or other computing devices (not shown) via one or more other communication network(s) 20. The network nodes 14(1)-14(n) may be hardware or software or may represent a system with multiple servers in a pool, which may include internal or external networks.

Although the network nodes 14(1)-14(n) are illustrated as single devices, one or more actions of each of the network nodes 14(1)-14(n) may be distributed across one or more distinct network computing devices that together comprise one or more of the server devices 16(1)-16(n). Moreover, the network nodes 14(1)-14(n) are not limited to a particular configuration and may be in private or public configurations. The network nodes 14(1)-14(n) may operate as virtual machines, for example. Thus, the technology disclosed herein is not to be construed as being limited to a single environment and other configurations and architectures are also envisaged.

The administrative client devices 18(1)-18(n) in this example include any type of computing device that can exchange network data, such as mobile, desktop, laptop, or tablet computing devices, virtual machines (including cloud-based computers), and the like. Each of the administrative client devices 18(1)-18(n) includes a processor, a memory, and a communication interface, which are coupled together by a bus or other communication link, although other types and/or another number of components could also be used.

The administrative client devices 18(1)-18(n) may, for example, run interface applications, such as standard web browsers or standalone client applications to, for example enter or revise one or more stored policies 40 and rules 42. The administrative client devices 18(1)-18(n) may further include a display device, such as a display screen or touchscreen, or an input device, such as a keyboard for example.

Although the exemplary blockchain system 10 with the blockchain monitoring computing device 12, network nodes 14(1)-14(n) of the blockchain network 16 operating in a virtual private cloud 19, administrative client devices 18(1)-18(n), and/or one or more other communication network(s) 20 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the blockchain system, such as the blockchain monitoring computing device 12, network nodes 14(1)-14(n) in the exemplary blockchain network 16, or administrative client devices 18(1)-18(n), for example, may be configured to operate as virtual instances on the same physical machine. In other words, one or more of the blockchain monitoring computing device 12, network nodes 14(1)-14(n) in the exemplary blockchain network 16, or administrative client devices 18(1)-18(n) may operate on the same physical device rather than as separate devices communicating through one or more other communication network(s) 20. Additionally, there may be more or fewer apparatuses, devices, or other elements than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, PDNs, the Internet, intranets, and combinations thereof.

The examples also may be embodied as one or more non-transitory computer readable media, such as the memory 24 of the blockchain monitoring computing device 12, having instructions stored thereon for aspect(s) of the present technology, as described and illustrated by way of the examples herein. The instructions in some examples include executable code that, when executed by one or more processors, such as the processor(s) 22 of the blockchain monitoring computing device 12, cause the processors to carry out steps necessary to implement the methods of the examples of this technology that are described and illustrated herein.

An exemplary method for executing an inventory to identify one or more blocks within a blockchain will now be described with reference to FIGS. 1-3. Referring more specifically to FIG. 3, in step 300 in this example, the listening module 30 executed by the blockchain monitoring computing device 12 uses a peer API of a blockchain protocol for the blockchain network 16 to transmit a request over the virtual private cloud 19 comprising “give me the last block ID” to request a latest or most current block from one of the network nodes 14(1)-14(n), although other manners for identifying a latest block in a blockchain can be used. For example, the one of the network nodes 14(1)-14(n) in the blockchain network 16 coupled to the blockchain monitoring computing device 12 may reply back with “block ID 10 is the latest block ID”.

In step 302, the blockchain monitoring computing device 12 may receive the latest identified block, in this example “block ID 10”, from the one of the network nodes 14(1)-14(n) over the virtual private cloud 19. In this example, the latest identified block is stored by the blockchain monitoring computing device 12 in the block storage database 38 using a bucket, folder, and filename so that the format can be read, for example by the storage engine 32 or the monitoring engine 34, for querying and manipulating the transaction data, although the latest identified block could be stored in other locations. Additionally, as part of the storage process in this example the storage engine 32 executed by the blockchain monitoring computing device 12 may parse the latest identified block into transactions which are stored in the block storage database 38, although the transactions may be stored in other locations and the blocks may be broken into transactions at other times in other examples.

In step 304, the listening module 30 executed by the blockchain monitoring computing device 12 to transmit a request over the virtual private cloud 19 comprising “give me the last block ID” to request again what is a latest or most current block from one of the network nodes 14(1)-14(n), although other manners for identifying a latest block in a blockchain can be used. For example, the one of the network nodes 14(1)-14(n) in the blockchain network 16 coupled to the blockchain monitoring computing device 12 may reply back with “block ID 13 is the latest block ID”, although other types of response may be received.

In step 306, the blockchain monitoring computing device 12 may receive the latest identified block, in this example “block ID 13”, from the one of the network nodes 14(1)-14(n) over the virtual private cloud 19. Again in this example, the latest identified block is stored by the blockchain monitoring computing device 12 in the block storage database 38 using a bucket, folder, and filename so that the format can be read, for example by the storage engine 32 or the monitoring engine 34, for querying and manipulating the transaction data, although the latest identified block could be stored in other locations. Additionally, as part of the storage process in this example the storage engine 32 executed by the blockchain monitoring computing device 12 may again parse the latest identified block into transactions which are stored in the block storage database 38, although the transactions may be stored in other locations and the blocks may be broken into transactions at other times in other examples.

In step 308, the blockchain monitoring computing device 12 may determine whether any blocks between the latest block and the immediately preceding latest requested block from the one of the network nodes 14(1)-14(n) are missing. If in step 308, the blockchain monitoring computing device 12 determines no block or blocks are missing, then the No branch is taken back to step 300 as described earlier.

If in step 308, the blockchain monitoring computing device 12 determines on or more blocks are missing, then the Yes branch is taken to step 310. In this particular example, the blockchain monitoring computing device 12 would determine that “block ID 11” and “block ID 12” are missing and the Yes branch would be taken to step 310. In step 310, the blockchain monitoring computing device 12 may receive the missing block or blocks, in this example “block ID 11” and “block ID 12”, from the one of the network nodes 14(1)-14(n) over the virtual private cloud 19. In this example, the missing block(s) is/are stored by the blockchain monitoring computing device 12 in the block storage database 38 using a bucket, folder, and filename so that the format can be read, for example by the storage engine 32 or the monitoring engine 34, for querying and manipulating the transaction data, although the missing block(s) could be stored in other locations. Additionally, as part of the storage process in this example the storage engine 32 executed by the blockchain monitoring computing device 12 may parse each of the missing block(s) into transactions which are stored in the block storage database 38, although the transactions may be stored in other locations and the missing block(s) may be broken into transactions at other times in other examples.

This example of the method may then return back to step 300 to repeat this process over and over to continue to acquire newly add blocks in the blockchain system 16. Additionally, in this example when the one of the network nodes 14(1)-14(n) replies back with a block ID in step 302 or step 306 that has already been seen, i.e. the latest identified block has already been received, then the listening module 30 executed by the blockchain monitoring computing device 12 may sleep for a short period of time, wake up, and restart this exemplary method at step 300 attempting to find new blocks in the blockchain, although other timing could be used, such as continuous searching.

An exemplary method for monitoring one or more schematized transaction within one or more blocks within a blockchain will now be described with reference to FIGS. 1-2 and 4. Referring more specifically to FIG. 4, in this example in step 400 the blockchain monitoring computing device 12 may ingest one of the transactions of a block of a blockchain stored in the block storage database 38, although the transaction could be obtain from other sources in other manners.

In step 402, the blockchain monitoring computing device 12 may parse the received transaction to determine a match with one of one or more stored serialization protocol stored, for example, in memory 24. Examples of serialization protocols which may be stored are JSON or XML, although other types of serialization protocols may be used.

In this example, the blockchain monitoring computing device 12 may attempt to parse the text of the transaction with each of the stored protocols in a sequential manner to identify a match with one of the stored protocols, although the analysis could be conducted in others manners, such as partially or entirely in parallel by way of example. Accordingly, in this particular example, the blockchain monitoring computing device 12 may first attempt to parse the text of the received transaction as JSON. For example, to determine if the parsed transaction is JSON, the blockchain monitoring computing device 12 may examine the parsed transaction for any attributes of JSON, such as “{” and/or “}” or are any sets of words summarized by “ ”. If an error is generated indicating an insufficient match, the blockchain monitoring computing device 12 determines that JSON is not a match, and a test on another of a plurality of stored serialization protocol is run. In this particular example, the blockchain monitoring computing device 12 may next attempt to parse the text as XML. For example, to determine if the parsed transaction is XML, the blockchain monitoring computing device 12 may examine the parsed transaction for any attributes of XML, such as “<” and/or “>”. If an error is not generated, then the blockchain monitoring computing device 12 in this example determines that XML is a match in step 402. If a match is not found, then the blockchain monitoring computing device 12 continues this process until a match is identified or the options of protocols are exhausted in this example.

In step 404, the blockchain monitoring computing device 12 may use the identified serialization protocol to schematize the transaction to identify fields for data types in the received transaction. By way of example, data types may be strings, integers, or dates of the fields. Additionally, by way of example, the blockchain monitoring computing device 12 may use the identified serialization protocol to identify one or more fields for one or more data types in the transaction to create the following schema for an exemplary transaction:

[{

“product-name”: “foo”,
“product-type”: [“bar”],
“factory”: [“Rochester”],
“quantity”: “250”,
“actions”: [“manufactured”]

}]

Different transactions can have different schemas, and even for a similar transactions the schema generated by the blockchain monitoring computing device 12 can have deviations. For example, in a blockchain that is used to track widgets in a supply chain, the schema for a transaction about a widget manufactured at a factory could be:

Product: Widget; Count: 100; Factoryname: Rochester; Color: Red; Size: Large; ProductUID: 35nw31;

Next, this set of widgets may be transferred from the factory to a warehouse so a different schema for another transaction about this could be:

ProductUID: 35nw31; ShipTo: WH9; Shipper: Fedex; TruckID: 4527; PickupDate: Mar. 4, 2020 9:14 am;

There are similar fields for each of these related transactions, but the fields in these schematized transaction can vary depending on the purpose and intent of the transaction. Additionally, these fields have data which can be compared against one or more conditions in the rules 42 for the policies 40.

In step 406, the blockchain monitoring computing device 12 determines when data in one or more of the identified fields of the schematized transaction match one or more conditions of one or more rules associated with one or more stored policies. As described by way of example earlier, the blockchain monitoring computing device 12 may have or access to a configuration database 38 with one or more different types of stored policies 40 correlated to one or more stored rules 42 each with one or more conditions and correlated to one or more executable actions 44. Also as described earlier, the stored policies 40 may include a variety of different types, such as infrastructure policies, user-generated policies, and behavioral policies.

In this example, to make this determination the monitoring engine 34 executed by the blockchain monitoring computing device 12 may load a list of stored policies 42 from the configuration database 38. As described earlier, the stored policies 40 are sets of rules 42 each with one or more conditions which the monitoring engine 34 uses to compare against data in the identified fields of the schematized transaction to detect when a correlated one or more of the executable actions should be triggered. As discussed earlier, in this example each of the rules 42 is mapped to one or more executable actions 44. In other examples, the monitoring engine 34 of the blockchain monitoring computing device 12 may use other manners for analyzing the schematized transaction.

If in step 406, the blockchain monitoring computing device 12 determines an executable action has not been triggered or otherwise identified, then the No branch is taken back to step 400 as described earlier to analyze and monitor the next transaction in this example. However, if back in step 406, the blockchain monitoring computing device 12 determines an executable action has been triggered or otherwise identified, then the Yes branch is taken back to step 410 as described below.

In step 408, the blockchain monitoring computing device 12 may trigger execution of at least one of the correlated executable actions 44 based on the determination that the data in at least one of the identified fields of the schematized transaction matches at least one of the conditions of one of the rules 42 associated with the at least one of the stored policies 40, although other types and/or numbers of other actions could be triggered or otherwise initiated in other examples. In this example, the executable action could be transmission of a notification12, such as a text message or an email, generated by the blockchain monitoring computing device about the condition and data that triggered the action.

By way of example, executable actions 44 can be defined against specific field names within a specific schema or against a field name in any schema. For example, the one of the stored policies 40 can specify a stored rule 42 with a condition as set forth below:

Alert when a field called foo has data >10

In another example, the one of the stored policies 40 can specify a more particular stored rule 42 with a condition as set forth below.

Alert when a field called FOO has data >10 and is part of the schema BAR

In another example, a user-generated policy with a rule having a condition as follows: “alert when the number of Widgets manufactured at factory Rochester is less than 1000 for the day”.

By creating and classifying transactions into schemas and having a configuration database with customizable policies 40, rules 42 with conditions, and executable actions 44 as illustrated by way of the examples herein, the blockchain monitoring computing device 12 can also execute a variety of analytics and queries against stored schematized transactions from one or more blocks of one or more blockchains and provide effective monitoring with respect to new and/or previously stored transactions. For example, the blockchain monitoring computing device 12 may receive a request to “show the top 5 transfers of FOO this week” from one of the administrative computing devices 18(1)-18(n), for example. Accordingly, the blockchain monitoring computing device 12 is able in this example to provide analysis of one or more schematized transactions based on stored policies correlated to rules with conditions tied to executable actions to provide ongoing effective monitoring of transactions in a blockchain.

In step 410, the blockchain monitoring computing device 12 may determine whether there are any additional transaction to monitor at this time. If the blockchain monitoring computing device 12 determines there are one or more additional transactions to monitor at this time, then the Yes branch is taken back to step 400 as described earlier. If the blockchain monitoring computing device 12 determines there are not any more additional transactions to monitor at this time, then the No branch is taken back to step 412 where the blockchain monitoring computing device 12 may sleep for a short period of time, wake up, and restart this exemplary method at step 400 attempting to process another transaction.

Accordingly, as illustrated and described by way of the examples herein, examples of the claimed technology provide a number of advantages including enabling effective monitoring of a blockchain based on schematized transactions. In particular, examples of the claimed technology provide a transparent infrastructure that enables monitoring of transactions within a blockchain and providing rules based executable actions when anomalous or other important events are detected. To enable this monitoring, examples of this technology use schemas on transactions within a blockchain to define fields and actions for data in those fields. Examples of this technology will derive the schema and use that information to monitor how transactions are being acted on. In addition to monitoring, examples of this technology also provide a set of default rules with conditions along with custom and behavioral rules with conditions used to detect when data in identified fields in a schematized transaction need an executable action to be triggered, such as a notification to an administrator of the blockchain or a security team supporting the blockchain.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for monitoring a blockchain based on one or more schematized transactions, the method comprising:
ingesting, by a computing device, a block of a blockchain for monitoring;
schematizing, by the computing device, a transaction of the block to identify one or more fields for one or more data types in the transaction;
determining, by the computing device, when data in one or more of the identified fields of the schematized transaction match one or more conditions of one or more rules associated with at least one stored policy; and
triggering, by the computing device, execution of at least one action based on the determination that the data in at least one of the identified fields of the schematized transaction matches at least one of the conditions of one of the rules associated with the at least one stored policy.

2. The method as set forth in claim 1 wherein the schematizing further comprises:
identifying, by the computing device, a correspondence of one of a plurality of stored protocols with the transaction, wherein the identified one of the protocols is used to identify the fields for the data types of transaction; and
schematizing, by the computing device, based on the identified one of the plurality of stored protocols.

3. The method as set forth in claim 1 further comprising:
requesting, by the computing device, a latest block entered in the blockchain from one of a plurality of network nodes in the blockchain network;
identifying, by the computing device, when there are any missing blocks between the latest block requested from the blockchain and the immediately previously latest block requested from the blockchain; and
obtaining, by the computing device, any of the missing blocks based on the identifying.

4. The method of claim 3 further comprising:
parsing, by the computing device, the received block of the blockchain into a plurality of transactions; and
storing, by the computing device, the plurality of transactions from the parsing of the received block of the blockchain.

5. The method as set forth in claim 1 wherein the at least one type of stored policies comprises at least one infrastructure policies, user generated policies, or behavioral policies.

6. The method as set forth in claim 5 further comprising:
training, by the computing device, artificial intelligence based on a sample of prior transactions to determine a threshold with respect to data in one of the defined fields;
configuring, by the computing device, at least one behavioral policy based on the determined threshold.

7. A non-transitory computer readable medium having stored thereon instructions comprising executable code that, when executed by one or more processors, causes the one or more processors to:
ingest a block of a blockchain for monitoring;
schematize a transaction of the block to identify one or more fields for one or more data types in the transaction;
determine when data in one or more of the identified fields of the schematized transaction match one or more conditions of one or more rules associated with at least one stored policy; and
trigger execution of at least one action based on the determination that the data in at least one of the identified fields of the schematized transaction matches at least one of the conditions of one of the rules associated with the at least one stored policy.

8. The medium as set forth in claim 7 wherein the executable code for the schematize the transaction of the block, when executed by the one or more processors further causes the one or more processors to:
identify a correspondence of one of a plurality of stored protocols with the transaction, wherein the identified one of the protocols is used to identify the fields for the data types of transaction; and
schematize based on the identified one of the plurality of stored protocols.

9. The medium as set forth in claim 7 wherein the executable code, when executed by the one or more processors further causes the one or more processors to:
request a latest block entered in the blockchain from one of a plurality of network nodes in the blockchain network;
identify when there are any missing blocks between the latest block requested from the blockchain and the immediately previously latest block requested from the blockchain; and
obtain any of the missing blocks based on the identifying.

10. The medium of claim 7 wherein the executable code, when executed by the one or more processors further causes the one or more processors to:
parse the received block of the blockchain into a plurality of transactions; and
store the plurality of transactions from the parsing of the received block of the blockchain.

11. The medium as set forth in claim 7 wherein the at least one type of stored policies comprises at least one infrastructure policies, user generated policies, or behavioral policies.

12. The medium as set forth in claim 11 wherein the executable code, when executed by the one or more processors further causes the one or more processors to:
train artificial intelligence based on a sample of prior transactions to determine a threshold with respect to data in at least one of the defined fields;
configure at least one behavioral policy based on the determined threshold.

13. A blockchain monitoring computing device, comprising memory comprising programmed instructions stored thereon and one or more processors configured to be capable of executing the stored programmed instructions to:
ingest a block of a blockchain for monitoring;
schematize a transaction of the block to identify one or more fields for one or more data types in the transaction;
determine when data in one or more of the identified fields of the schematized transaction match one or more conditions of one or more rules associated with at least one stored policy; and
trigger execution of at least one action based on the determination that the data in at least one of the identified fields of the schematized transaction matches at least one of the conditions of one of the rules associated with the at least one stored policy.

14. The device as set forth in claim 13 wherein for the schematize the transaction of the block, the one or more processors are further configured to be capable of executing the stored programmed instructions to:
identify a correspondence of one of a plurality of stored protocols with the transaction, wherein the identified one of the protocols is used to identify the fields for the data types of transaction; and
schematize based on the identified one of the plurality of stored protocols.

15. The device as set forth in claim 13 wherein the one or more processors are further configured to be capable of executing the stored programmed instructions to:
request a latest block entered in the blockchain from one of a plurality of network nodes in the blockchain network;
identify when there are any missing blocks between the latest block requested from the blockchain and the immediately previously latest block requested from the blockchain; and
obtain any of the missing blocks based on the identifying.

16. The device of claim 13 wherein the one or more processors are further configured to be capable of executing the stored programmed instructions to:
parse the received block of the blockchain into a plurality of transactions; and
store the plurality of transactions from the parsing of the received block of the blockchain.

17. The device as set forth in claim 13 wherein the at least one type of stored policies comprises at least one infrastructure policies, user generated policies, or behavioral policies.

18. The device as set forth in claim 17 wherein the one or more processors are further configured to be capable of executing the stored programmed instructions to:
train artificial intelligence based on a sample of prior transactions to determine a threshold with respect to data in at least one of the defined fields;
configure at least one behavioral policy based on the determined threshold.
